(19) United States
(12) Patent Application Publication
(10) Pub. No.: US 2013/0061522 A1
(43) Pub. Date: Mar. 14, 2013

(54) Flood Protection Device

(71) Applicants: John Reginald Alexander, Warwickshire (GB); Brian Frederick Clegg, St. Aubin le Cloud (FR); Peter Emmons, Fareham (GB)

(72) Inventors: John Reginald Alexander, Warwickshire (GB); Brian Frederick Clegg, St. Aubin le Cloud (FR); Peter Emmons, Fareham (GB)

(73) Assignee: EINSTEIN IP LIMITED, Tonbridge, Kent (GB)

(21) Appl. No.: 13/696,626

(22) PCT Filed: May 9, 2011
(86) PCT No.: PCT/GB2011/050885

§ 371 Date: Nov. 7, 2012

(30) Foreign Application Priority Data
May 7, 2010 (GB) 1007666.9

(51) Int. Cl. E06B 9/68; E06B 1/00; E06B 9/00; E06B 9/56

(52) U.S. Cl. CPC E06B 9/68; E06B 9/56; E06B 1/003
USPC 49/11; 49/10; 49/70

(57) ABSTRACT

The flood protection device is a door, patio door, window, french window, garage door or similar solution for closing apertures in buildings offering flood protection up to a predetermined height that includes a number of conduits which may be installed within a wall, a window, door or any other barrier in the outer perimeter of a building and conduits that extend through the barrier to allow water to enter into the building above the pre-determined height. The conduits are sited at a height at or below the height at which the force exerted upon the barrier by external water is equal to the maximum force which the barrier can withstand without undergoing failure. The flood protection device may be fitted with a visual and audible internal indicator and locking or disabling mechanism to prevent the device being opened in the presence of flood water.

The present invention relates to a flood protection device. The flood protection device is an openable barrier present in the external boundary of a building such as a door, patio door, window, french window, garage door or similar device. The openable barrier is configured to provide flood protection up to a predetermined height and including a conduit or any number of conduits inserted at a predetermined height that will allow flow of flood water through the barrier to help prevent structural damage to the opening and adjacent walls. The flood protection system may include one or more of a U-shaped sealing strip, multiplicity of enhanced seals, adapted compression rollers, self-adjusting hinges, a retractable horizontal sealing bar, re-enforcement of openable barrier and the frame it sits in, sealing of any cavities and gaps in the openable barrier, a cavity plate across the inner and outer leaves of a cavity wall and an indicator and a locking or disabling mechanism to warn of external flood water and prevent the opening of the flood protection device.

In the UK, more than 1 in every 6 homes is at risk of flooding. Climate change is likely to see this figure rise, and the annual probability of flooding to each property continues to increase despite efforts by Government to reduce the risk.

The UK's planning laws seek to mitigate future flood risk by providing the means to control development in flood risk areas. The laws generally make the presumption that development will not occur in flood plain areas; however developments may still occur in these regions provided they meet certain criteria. Owners of property within flood plain areas are responsible for using designs which reduce a development's flood risk by including, where necessary, flood resilience measures.

Developments in flood plain areas are often constructed using flood-resistant construction methods, i.e. construction methods that are designed to prevent or minimise water entry into a building where there is flooding outside.

Due to rising incidences of serious flooding there has been a growing demand for flood protection for individual properties, especially those which have already been constructed. The flood protection is mainly focused on the building apertures, such as doors window and airbricks, which provide the primary routes for floodwater to enter a building. This flood protection generally falls into one of two categories: wholly removable flood protection or demountable flood protection. Whilst removable flood protection devices to protect building apertures are the most popular, generally, the most effective forms of flood protection are demountable. Demountable flood protection includes some permanent elements which are used to help deploy the flood protection when flooding is threatened. It is these permanent elements that have caused demountable flood protection to be resisted by a large portion of the market due to the risk of flooding being advertised by the presence of the permanent elements of the systems, or the need for a human to deploy the demountable system.

Due to both temporary and demountable flood protection systems requiring human intervention at the time of flooding to deploy the system there is a significant risk of non-deployment or incorrect deployment of the system. For this reason, at least in part, other measures such as elevating the building are regarded as preferable to removable and demountable systems under planning law.

For a door to provide protection against flooding the door has to be engineered to resist the force imparted on it by a full height head of water. Typically, to withstand this type of loading, the door is constructed from thick gauge steel which increases the cost of the door considerably and diminishes the aesthetic appeal. If the door is not sufficiently engineered to resist the load on it from floodwater it may leak or even suffer catastrophic failure leading to significant flooding inside the building.

Additionally, whilst the door must be able to withstand forces imparted on it by floodwater, the presence of these forces will also result in additional forces being exerted on the wall or part of the property to which it is connected. At times of significant flooding, the load on the connection between the door and the property or on the wall itself may be excessive and provide a point of failure leading to flooding inside the property. Generally, when flood-doors are installed in a property there is no legal requirement to assess the loading strength of other parts of the building, which may increase the risk of flooding.

Furthermore the wall or walls of a building may also be damaged by water pressure directly exerted on them.

Failure of any structural part of a building such as a door or wall will, in general, permit rapid entry of water into the building. In addition to the damage caused by the presence of water and forces exerted by it, the floodwater will also carry debris which will increase the damage to the fabric of the building and its contents.

Thus, it is important to take into account the loads which may be exerted upon a building during flooding, and the load which the component parts of a building can withstand when developing flood defence mechanisms.

According to the present invention there is provided a flood defence device comprising: means for closing an aperture in an external perimeter structure in a building, the means being configured to prevent ingress of fluid through the external perimeter structure up to a predetermined height; and one or more conduits, the conduits adapted to allow liquid flow through the external perimeter structure when the fluid height is greater than the predetermined height.

By placing conduits at this height to allow water to enter the building before the maximum force the structure can withstand is reached enables the amount of structural damage to the building to be minimised whilst also minimising the likelihood of water entering a building. It is generally not sufficient to rely upon passive means such as incidental leakage through doors and windows to inundate the interior of the building as the leakage rate may not be sufficient to prevent an excess differential load to build up where the rate of rise in flood level externally exceeds the rate of rise to the internal of the building.

The device may include a means to control the flow of fluid through the conduit by controlled inundation of the internal of the building at a predictable rate, appropriate for the anticipated flood conditions i.e slow rising fluvial flood or flash flood.

For example, one or more of the conduits may be provided with a float valve. The float valve may comprise, for example, a frame and a buoyant element, the buoyant element adapted to move between a closed position where fluid passage through the conduit is obstructed by the closure and an open position in which fluid passage through the conduit is enabled.

The valve is placed within or in registration with the opening of the conduit such that when there is no flood water the opening of the conduit is closed. This means that no draughts enter the building via the conduits. In contrast, when the level of the flood water is high enough it causes the closure to float and gradually move towards the open position enabling water to enter into the conduit. In this way the valve is only opened in the presence of flood water at a height great enough to require ingress through the conduits.

Alternatively, the means to control the flow of fluid through the conduit may comprise a closure means having an open configuration where fluid can pass through the conduit and a closed configuration where fluid is prevented from passing through the conduit, and a monitoring means, the monitoring means being configured to control the closure means. This enables the conduits to be placed near to the base of the perimeter structure (such as a wall or door) and therefore be less unsightly whilst preventing entry of water until the height of the water produces forces on the building which may result in structural damage.

The monitoring means may comprise a tensioned spring member configured to exert pressure on the closure means, such as a flap, to maintain it in a closed configuration in the absence of any opposing force on the closure means. When the pressure of the water increases the force on the spring member increases, until the spring member is compressed causing the flap to tilt and allowing water to flow through the conduit.

The monitoring and closure means may be integral and comprise a rubber throat present in the conduit, in the closed configuration opposing sides of the rubber throat meet to prevent fluid flow through the conduit.

Optionally, the monitoring means may comprise means to detect presence of a liquid and is configured to cause the closure means to move to an open configuration on detecting the presence of a liquid.

One of the one or more conduits may be provided with a water permeable membrane such as a geo-synthetic material or other materials of similar property of water permeability. This acts to control the rate of flow of water into the building according to the size and placement of the conduit, and the permeability of the membrane. Additionally the membrane prevents entry of debris through the conduit and reduces air transmission and therefore helping to reduce thermal loss.

Larger bodies can be prevented from entering and the membrane itself protected by use of a gauze or grille across the passage of the conduit. Alternatively the conduit may be provided in the form of a baffle so that the tubes placed at an advantageous angle can provide free-flow of flood water to the interior. The baffle, membrane, gauze, grille and float valve may be used in any combination in a conduit or in multiple conduits.

The float valve, water permeable membrane or baffle may be configured to only let water through the conduit when pressure on the conduit is greater than a predefined pressure. For example, the predefined pressure may be equal or less than the maximum pressure that can be exerted upon the structure without failure of the structure. This enables entry of water into the building to be prevented until water needs to be allowed into the building to maintain the structural integrity of the building.

The conduits may be horizontal or up to 80 degrees from the horizontal axis with the internal opening being lower than the external opening.

In accordance with further aspects of the present invention the flood defence device may be a door, a window, a patio door, a bi-fold door, a stable door, a French window or a garage door including any one or more of the features described above.

The door or window may be mountable in a frame using a hinge which allows sealing compression on the hinge side and minimises pinching of the seal. Preferably, the hinge is designed to increase sealing on the side of the hinge in the presence of compression. The design may utilise a double axis and a spring to allow flexible closing motion.

The door or window may be provided with sealing means, the sealing means extending at least as high as the level of the flood defence device; alternatively the sealing means may only extend as high as the level of the flood defence device. The sealing means need only extend as high as the level of the flood defence device as when the water exceeds this height its entry into the building is enabled via the conduits.

Preferably, the sealing means is adapted to form a water-tight seal when the door or window is under compression such that the pressure of water on the door or window increases the seal. The sealing means may comprise a projection and a neoprene strip, the projection and neoprene strip each being situated on the door and/or the frame and being in registration with each other; such that when the door or window is compressed the projection is forced into the neoprene strip thereby giving a waterproof seal.

Alternatively the sealing strip may be of a magnetic strip on the door or window with a mating magnetic material on the door or window frame or vice versa.

The door, window, patio door or any other door frame may be provided with re-inforcement. If the door or window frame is hollow the reinforcement may comprise inserting a substance into at least part of the space within the door or window frame. The substance may be, for example, metal framework or expanding foam or resin which would also have the benefit of sealing the internal cavities.

The door or window may be provided with a rack and pinion locking mechanism. The rack and pinion locking mechanism may be operated by a handle, roller chain, cable or motorised mechanism and may include a locking and sealing member comprising a compression roller, locking bolt and sealing bar.

In accordance with another aspect of the present invention there is provided a wall including the flood defence device including one or more of the features described above.

The wall may be a cavity wall with a cavity beam inserted between the inner and outer leaves of the wall. This will have the benefit of spreading the load between the inner and outer leaves of the wall, and across bricks/blocks to avoid structural failure. If the outer frame is fixed directly to this cavity beam it will have the potential to avoid point loading.

The flood defence device may include a visual and/or audible internal indicator that signals the presence of flood water outside the door will highlight the need to use an alternative route to exit the building.

The visual and audible internal indicator may also be connected to a locking or disabling mechanism that prevents the opening of the door during a flood. This will prevent an excess ingress of water into the building.

A specific embodiment of the present invention will now be described by reference to the following drawings in which:

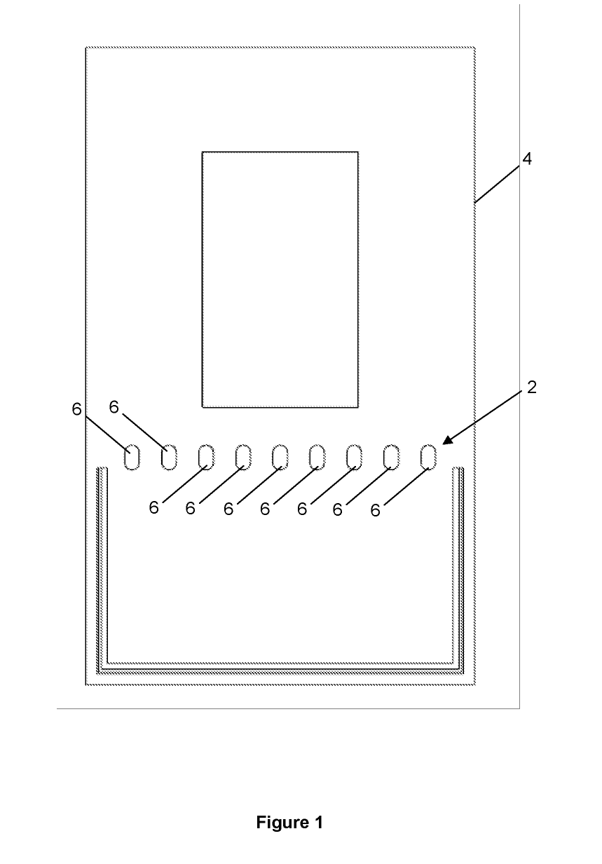

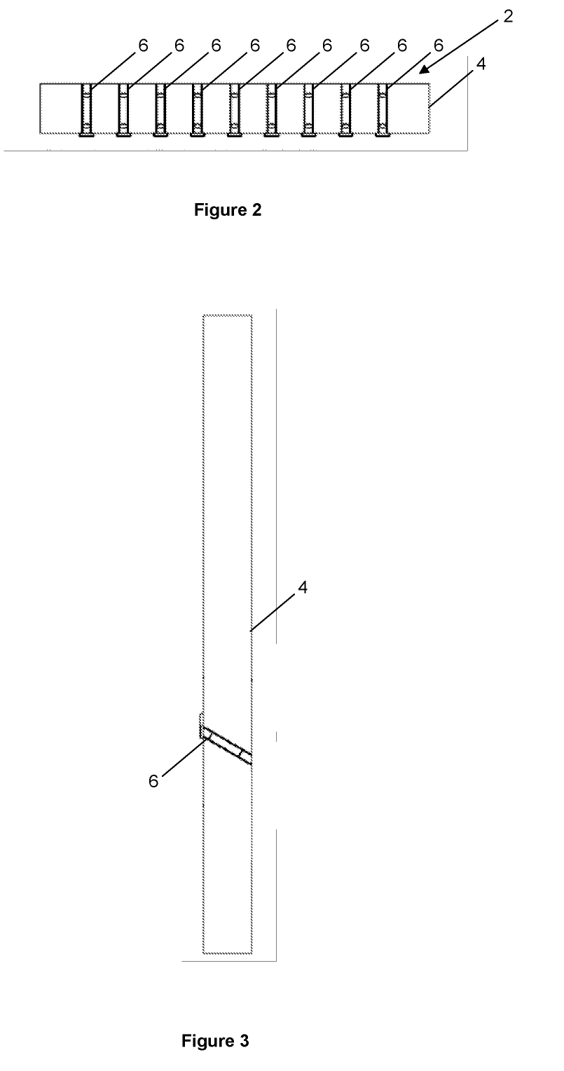

FIGS. 1 to 3 illustrate views of a door in accordance with the present invention;

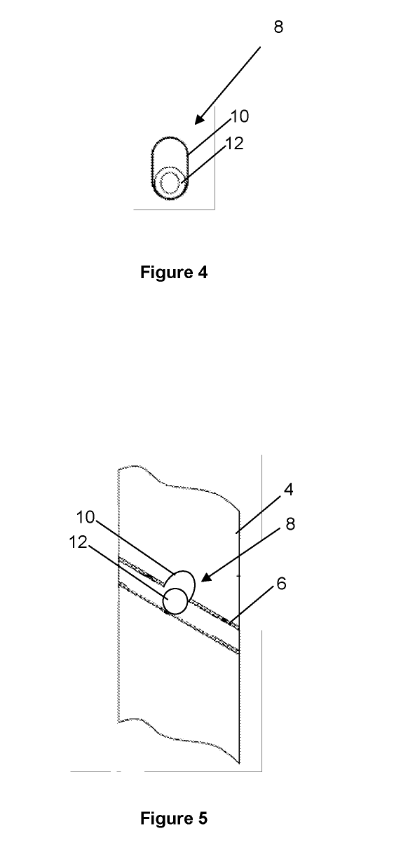

FIGS. 4 and 5 illustrate float valves in use in the present invention;

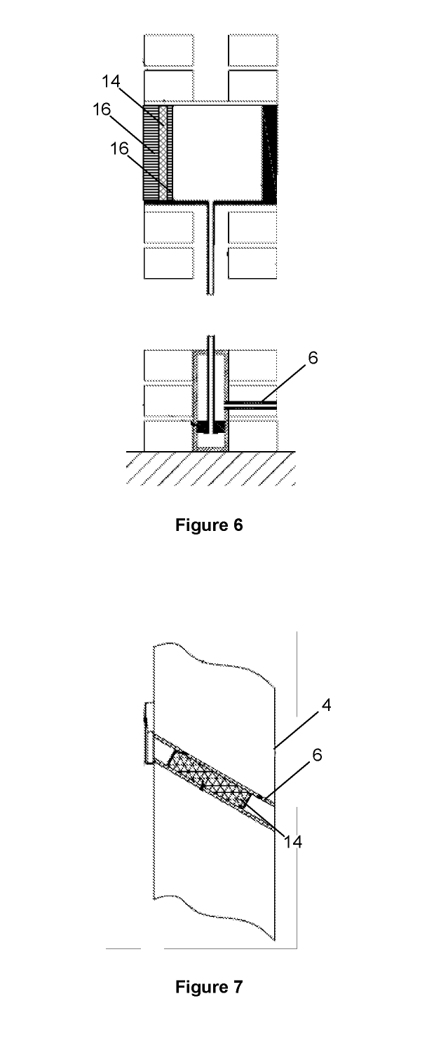

FIG. 6 illustrates an alternative closure mechanism;

FIG. 7 illustrates an alternative arrangement in accordance with the present invention;

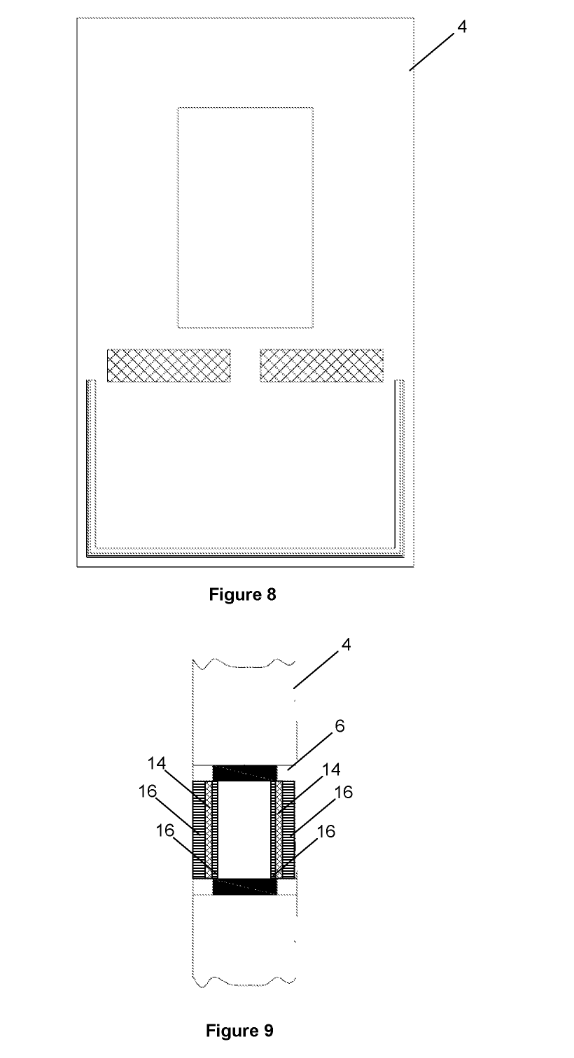

FIG. 8 illustrates a door including an external grille;

FIG. 9 illustrates a possible conduit, grille, water-permeable membrane configuration;

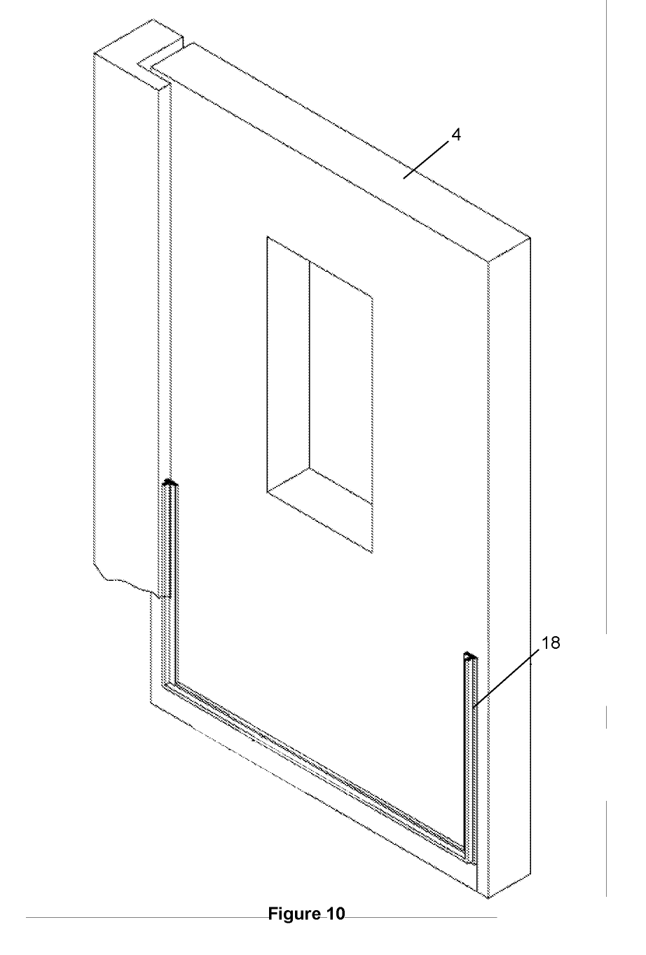

FIG. 10 illustrates a door including a sealing strip;

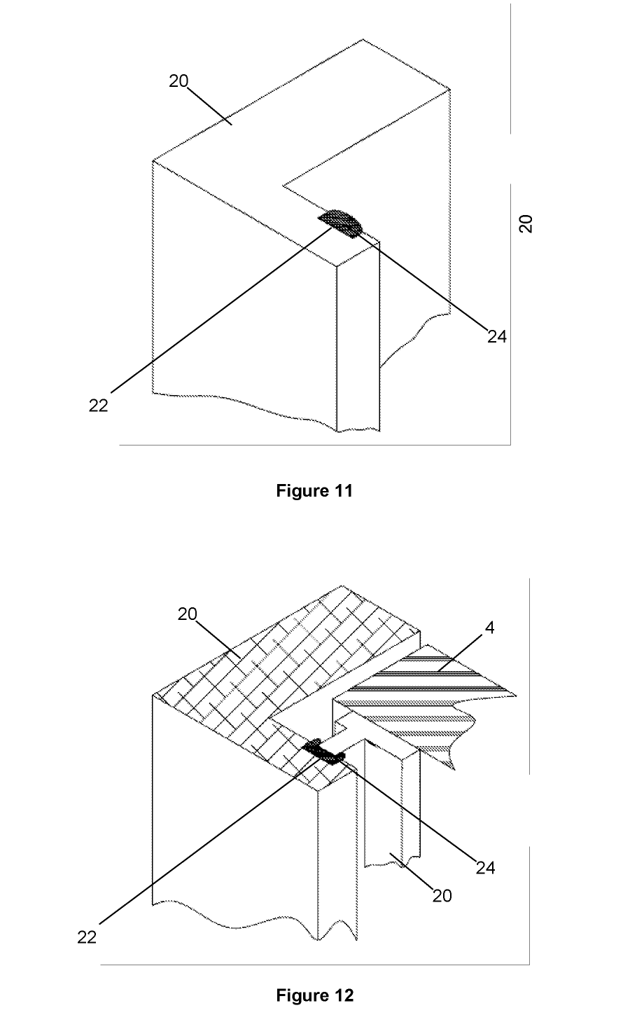

FIGS. 11 and 12 illustrate a frame including a sealing strip both in and out of registration with a door;

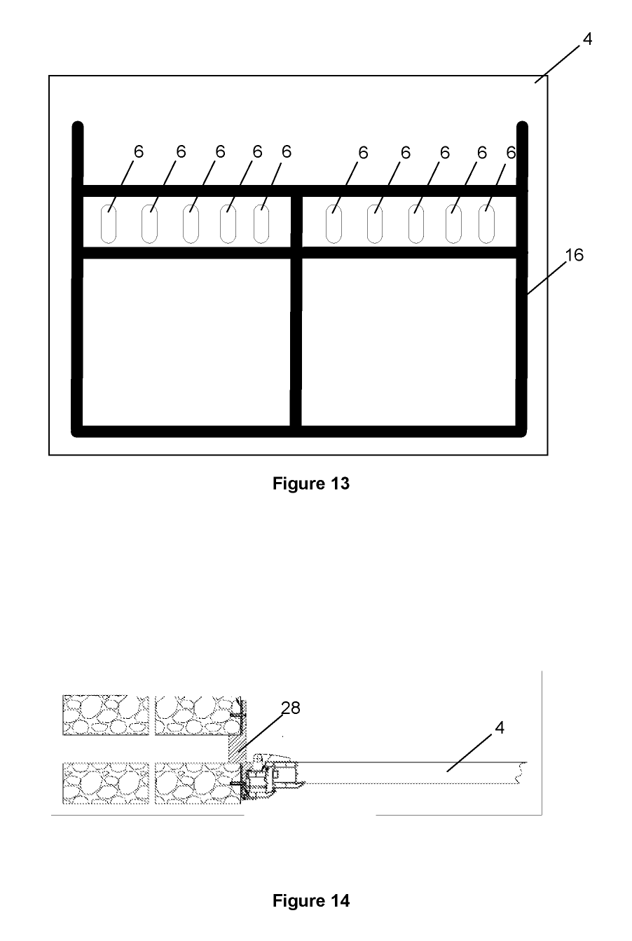

FIG. 13 illustrates a door including reinforcement;

FIG. 14 illustrates a cavity including sealing means;

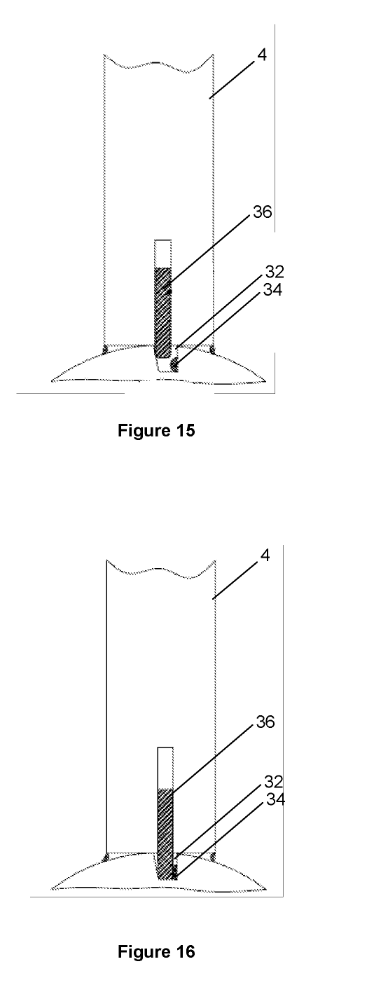

FIGS. 15 and 16 illustrate a locking mechanism provided with a seal;

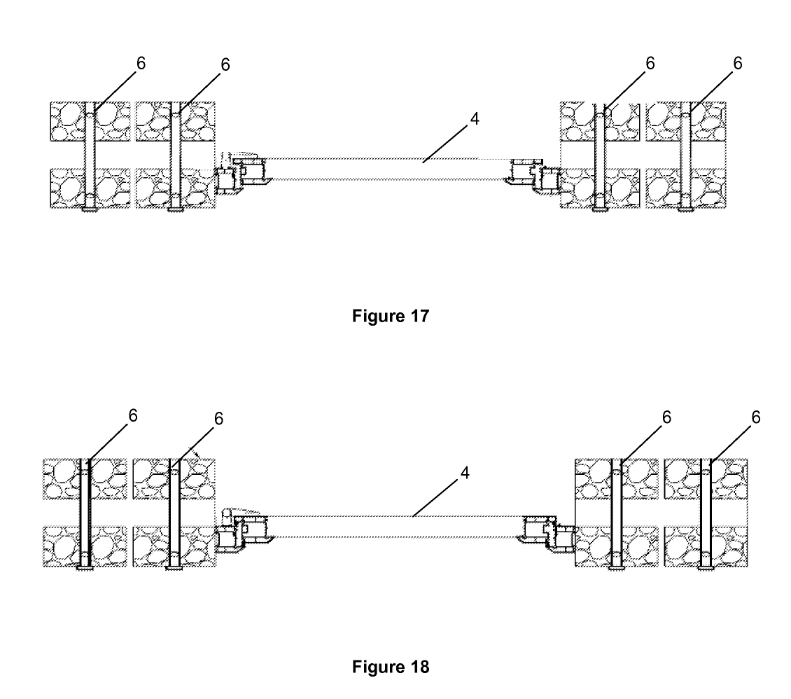

FIG. 17 illustrates a wall including the equalisation device of the present invention;

FIG. 18 illustrates a wall including the equalisation device of the present invention including float valves;

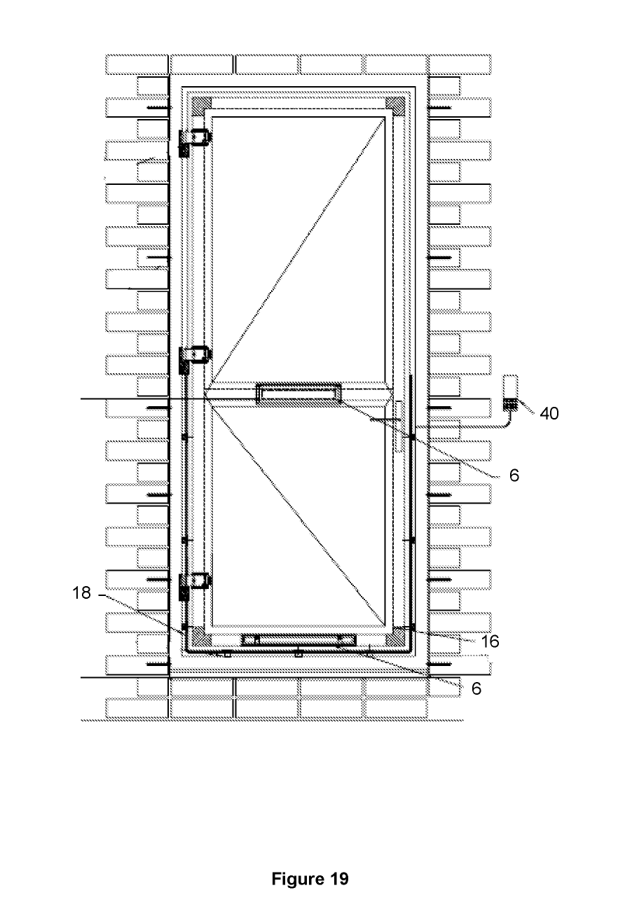

FIG. 19 illustrates a door including an indicator;

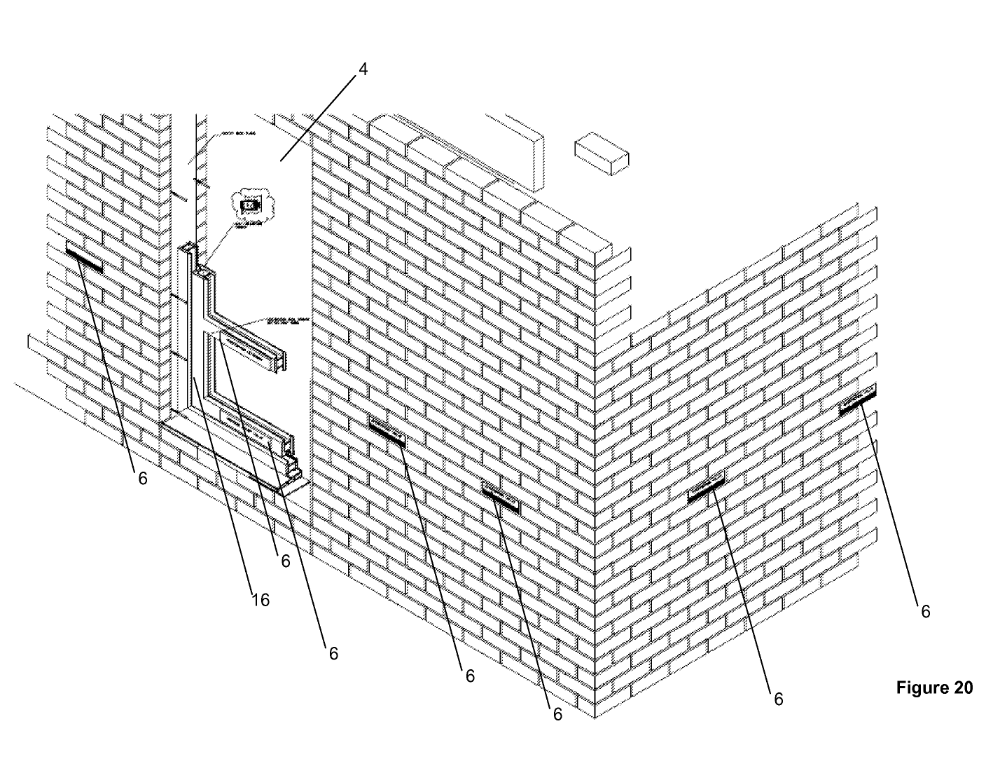

FIG. 20 illustrates a door in accordance with the present invention installed in a wall; and

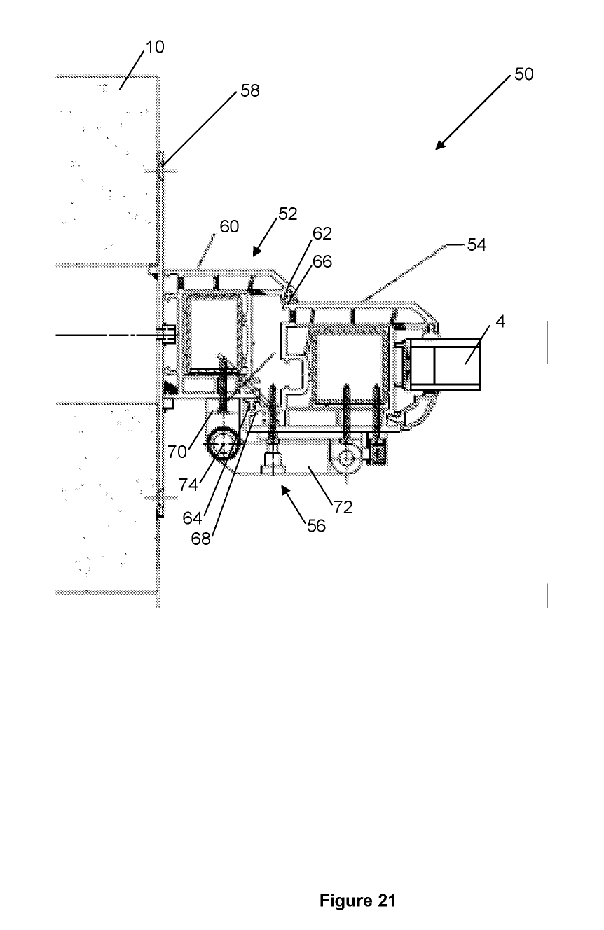

FIG. 21 illustrates a hinge device of the present invention.

FIGS. 1 to 3 illustrate an equalisation device 2 in a door 4. The equalisation device 2 comprises one or more conduits 6 passing through the depth of the door 4 such that fluid can flow from one side of the door 4 to the other through the conduit 6.

One or more of the conduits 6 are situated at a predetermined height. The predetermined height being equal or below the height at which the force of water on the door 4 is equal to the maximum force the door 4 can withstand without undergoing failure. By placing one or more of the conduits 6 at this height water is allowed to enter the building to maintain the inward pressure on the door 4 at or below the maximum force which the door 4 can withstand without failing.

The ingress of water into the building through the conduits 6 relieving the force on the door 4 minimises the chances of structural failure in the door 4.

The conduits 6 may be angled, rather than horizontal. Preferably, they are angles up to 80 degrees from horizontal. The angling of the conduits 6 in to the building facilitates may reduce the passage of direct airflow through the conduits 6 into the building when flooding is not present, thereby reducing draughts due to the presence of the conduits 6.

The conduits 6 may be provided with means to control the ingress of water. For example, they may be provided with a float valve 8 externally as shown in FIG. 4 or internally as shown in FIG. 5. The external float valve 8 or buoyant flap comprises a frame 10 and a moveable closure 12, the frame 10 having a length which is greater than the length of the closure 12 such that the closure 12 can move along the length of the frame 10. When the closure 12 is at one end of the frame 10 it covers the opening to the conduit 6 (as shown in FIG. 4) and prevents fluid flow therethrough; as the closure 12 moves along the frame 10 towards the other end it gradually reveals the opening of the conduit 6 and allows water to flow through the conduit 6 into the building.

The closure 12 is made of a buoyant element which floats in water, this means that when the water level reaches the closure 12 the closure 12 floats on the water. As the floodwater raises the closure 12 it gradually opens the valve allowing water to flow through the conduit 6. Thus, the conduit 6 is only open in the presence of floodwater. By selectively closing the entrance to the conduit 6 when there is no floodwater, or the floodwater is below the predefined level, draughts through the conduit 6 in the building are prevented.

The internal float valve is present within the passage of the conduit 6 and works in the same manner as the external float valve. The internal float valve in a closed conformation is illustrated in FIG. 5.

Alternatively or to increase the inflow of flood water into the building to reduce risk of structural damage, a normally-closed conduit 6 may be installed at below the defined protection level. The conduit 6 is provided with a closure mechanism which, in an open configuration, allows fluid flow through the conduit 6 and, in a closed configuration, prevents fluid flow through the conduit 6. This conduit 6 is connected to a monitoring means, in this instance an inlet valve placed at or above the defined protection level. When water enters the inlet valve, or is detected by the monitoring means, the inlet valve causes the closure mechanism to move to an open configuration to allow flow of flood water. The conduit 6 and/or the inlet valve could be installed in the door 4 or wall.

Alternatively, the monitoring means may be an appropriately tensioned spring member integral with the closure mechanism. The closure mechanism is normally maintained in the closed configuration by pressure from the spring member. However, pressure on the closure mechanism is transferred to the spring member and, when the pressure is to the pre-defined level of flood protection the spring is compressed sufficiently that the closure mechanism is, at least partially, in an open configuration.

Alternatively the closure mechanism may comprise a normally-closed rubber throat in the conduit 6. The rubber throat only providing passage through the conduit 6 when pressure equivalent to the pre-defined level of flood protection is exerted on it.

The conduit 6 may also be provided with a water permeable medium within it, for example, as shown in FIG. 7. This water permeable medium 14 may comprise a perforated baffle, geo-synthetic material or other material of similar water-permeability.

Larger bodies can be prevented from entering and the membrane 14 itself protected by use of a gauze or grille 16 across the passage of the conduit 6 as illustrated in FIGS. 8 and 9. Alternatively the conduit 6 may be provided in the form of a baffle so that the tubes placed at an advantageous angle can provide free-flow of flood water to the interior. The baffle, membrane, gauze, grille and float valve may be used in any combination in a conduit 6.

One example of a grille 16 in use in combination with a water-permeable membrane is in FIG. 9. The grille 16 may be present on either side, or both sides of the water-permeable membrane 14.

When the equalisation device 2 is installed in an openable member such as a door 4 or window that member may be provided with a seal. The seal will now be described with reference to FIGS. 10 to 12 in relation to its implementation in a door 4. One example of such a seal is the use of a projection 18 attached to the door 4. The frame 20 for the door 4 is provided with a groove 22 in registration with the projection 18 attached to the door 4. A waterproof compressible material 24 is provided within the groove 22. The presence of the compressible material 24 means that when the door 4 is closed the projection 18 is received in the compressible material 24 partially compressing it and creating a seal as illustrated in FIG. 12.

The rigid projection 18 may be made from any suitable material such as any ferrous or non-ferrous metal, PVC, GRP, either connected to the door 4 or frame, or integral with the door 4 or frame 20. The projection 18 may be formed with a T cross-section or any other suitable cross-section.

The waterproof material 24 may be, for example, a neoprene seal, rubber, silicone or any other suitable material. Additionally, it may not be provided within a groove 22 but the presence of the groove 22 increases the sealing around the door 4.

A plurality of sealing strips and seals may be provided on either or both of the door 4 and frame in order to provide a plurality of barriers to water entry.

The seal may extend all the way around the door 4. Alternatively, the seal may only extend around the base of the door 4 and up to the height of the equalisation device 2.

Alternatively the sealing strip may be of a magnetic strip on the door 4 or window with a mating magnetic material on the door 4 or window frame or vice versa.

The door 4 into which the equalisation device 2 is inserted may be re-inforced to increase the loading force which the door 4 can withstand. For example, the barrier may be a hollow door, such as a uPVC door. In this instance, the reinforcement may take the form of a resin or other suitable filler substance, and/or metal inserts 26 into the door 4 as illustrated in FIG. 13.

Preferably, the door 4 is reinforced, at least to the height at which the equalisation device 2 is positioned i.e. the maximum level allowed for the water to achieve before it is allowed to ingress into the building. Additionally, the door 4 may be reinforced about the conduits 6 to prevent buckling at the point of water ingress.

The wall to which the door 4 is connected may also be re-inforced if it is a cavity wall by inserting a cavity frame between the inner and outer portions of the wall. The cavity frame acts to spread the load across the cavity and spread the load across several bricks/blocks in the supporting wall.

The cavity frame may be made from steel, GRP or any other sufficiently strong material. It may be cut to measure for each installation or fabricated in bespoke sizes. It may be separate from, or attached to the door 4 frame.

The cavity may also be sealed using any suitable sealing material, for example, neoprene, as illustrated in FIG. 14. The seal 28 acts to prevent water entering the cavity of the wall.

Optionally, the door 4 may be attached to the door frame using a suitable hinge which allows sealing compression on the hinge side.

Additionally, the door 4 may be provided with a rack and pinion locking mechanism to transfer motion and force from one plane to another to enable sealing and/or locking of the hinge side of the door 4 and/or the bottom of the door 4. This may preferably be operated by the conventional door handle, which is connected via rack and pinion to the locking and sealing members.

Alternatively roller chain, cable or motorised mechanisms e.g. solenoid could be utilised.

The locking and sealing members may comprise of compression rollers, locking bolts and sealing bars.

Preferably a retractable locking and sealing bars are forced vertically down at the bottom of the door 4, or may be forced outward at the sides to engage a slot in the outer door-frame creating a seal. The overall door seal may be enhanced by an advantageous angle on the receiving slot and a ball or other advantageous shape to the head of the retractable sealing bar. This will provide further compression by forcing the door 4 against the outer frame. This may be in place of or in addition to conventional compression rollers.

The locking bar and receiving slot are preferably provided with an additional seal, for example as illustrated in FIGS. 15 and 16. The receiving slot 32 is provided with a waterproof compressible material 34, as described with reference to FIGS. 10 to 12, and the locking bar 36 is configured to contact the waterproof compressible material 34 when it is in a locked configuration thereby to provide a seal.

As will be understood by the skilled person the equalisation device 2 may be inserted in any structure which forms the outer boundary of a building. For example, it may be included in a wall or door 4 as illustrated in FIGS. 17 and 18. A cavity frame may also be used to reinforce a cavity wall around the equalisation device 2 in this instance.

It may be provided integrally within the structure when it is made or, alternatively, be provided within an insert that is inserted into the structure. For example, the conduits may be provided within a structure suitable for attachment to glass.

Additionally, the skilled person would understand that the conduits may be provided at alternative heights and not along a single plane in order to vary the rate at which water ingress occurs dependent upon the force of the building. This means that a higher rate of water ingress can be effected when the building is subject to a rapid rise in water levels.

The door may include an indicator 40 as illustrated in FIG. 19. The indicator 40 may be visual in nature or audible. For example, it may consist of a simple transparent tube with a floating ball indicator that fills with flood water to indicate the presence of flood water outside the door. Alternatively, the indicator 40 may include an electronic circuit including a water sensor. This may be powered by mains electricity, battery or a sustainable source such as photovoltaic or wind/water turbine.

In alternative embodiments the indicator may include a light which becomes illuminated or a speaker which emits a sound when the flood water is above a predetermined limit.

The indicator may be connected to a locking or disabling device (not shown) that prevents the door being opened when flood water is indicated outside the door. An example of such a device is a lever that prevents the turning of the door handle when the water level is raised. This lever may be driven by a water wheel connected to the indicator and then by a series of cogs that drop the lever into a position that locks or disables the handle.

FIG. 21 illustrates an example of a hinge 50 which may be used to mount the door or window 4 in a frame 10. The hinge, as will be described below, allows sealing compression and minimises pinching of the seal on the hinge side. The design may utilise a double axis and a spring to allow flexible closing motion so that as the handle side is rotated to closure the hinge side may remain loose until closure is complete. Preferably, the hinge is designed to increase sealing on the hinge side of the door in the presence of compression.

In FIG. 21 it can be seen that the hinge 50 has a frame portion 52 which is attachable to the frame 10 of the door or window and a door portion 54 which is attachable to the door or window. The frame portion 52 and the door portion 54 are connected to one another by a spring 56 which is attached at one end to the frame portion 52 and the other to the door portion 54.

The frame portion 52 includes a bracket 58 attaching the frame portion 52 of the hinge 50 to the frame 10. The bracket may comprise one or more plates which may be attached to the frame using screws, nails or any other fastening means. Connected to the bracket is at least one sealing portion which is provided with sealing means 62 and 64 which will be described in more detail below.

The door portion 54 also includes means for attaching the door portion to a door, window or any other hingeable aperture closing device, for example using compression on the door. The door portion is also provided with one or more sealing means 66, 68 which are complementary to the sealing means present on the frame portion 52.

The spring 68 comprises a first arm 70 which is attached at one end to the frame portion 52 and a second arm 72 which is attached at one end to the door portion 54. The arms 70 and 72 may be attached to the frame and door portions using screws, nails or any other suitable means. The arms are connected at the other end by a spring 74 or other elastic means. The spring 74 acts to force the arms to bring the sealing means of the frame portion 52 and the door portion 54 in contact with one another to form a seal in the hinge portion.

The sealing means may comprise, for example, a projection 64, 66 on either the frame portion 52 or the door portion 54 which is received in a complementary receiving means 62, 68 to provide a seal between the frame portion 52 and the door portion 54.

1. A flood defence device comprising:
(a) means for closing an aperture in an external perimeter structure in a building, the means being configured to prevent ingress of fluid through the external perimeter structure up to a predetermined height;
(b) one or more conduits, the conduits adapted to control liquid flow through the external perimeter structure when the fluid height is greater than the predetermined height.

2. A flood defence device as claimed in claim 1 further comprising a means to control the flow of fluid through the conduit.

3. A flood defence device as claimed in claim 2 wherein the means to control the flow of fluid through the conduit is a float valve.

4. A flood defence device as claimed in claim 2, wherein the means to control the flow of fluid through the conduit is internal to the conduit or in registration with the opening of the conduit.

5. A flood defence device as claimed in claim 3, wherein the float valve comprises a frame and a buoyant element, the buoyant element adapted to move between a closed position where fluid passage through the conduit is obstructed by the closure and an open position in which fluid passage through the conduit is enabled.

6. A flood defence device as claimed in claim 2 wherein the means to control the flow of fluid through the conduit comprises a closure means having an open configuration where fluid can pass through the conduit and a closed configuration where fluid is prevented from passing through the conduit, and a monitoring means, the monitoring means being configured to control the closure means.

7. A flood defence device as claimed in claim 6 wherein the monitoring means comprises a tensioned spring member configured to exert pressure on the closure means to maintain it in a closed configuration in the absence of any opposing force on the closure means.

8. A flood defence device as claimed in claim 6 wherein the monitoring and closure means are integral and comprise a rubber throat present in the conduit, in the closed configuration opposing sides of the rubber throat meet to prevent fluid flow through the conduit.

9. A flood defence device as claimed in claim 6 wherein the monitoring means comprises means to detect presence of a liquid and is configured to cause the closure means to move to an open configuration on detecting the presence of a liquid.

10. A flood defence device as claimed in claim 1, wherein one of the one or more conduits is provided with a water permeable member.

11. A flood defence device as claimed in claim 10 wherein the water permeable member comprises a baffle.

12. A flood defence device as claimed in claim 2, wherein the means to control the flow of fluid through the conduit, water permeable membrane or baffle are configured to only let water through the conduit when pressure on the conduit is greater than a predefined pressure.

13. A flood defence device as claimed in claim 12 wherein the predefined pressure is equal or less than the maximum pressure that can be exerted upon the structure without failure of the structure.

14. A flood defence device as claimed in claim 1, wherein the conduits are horizontal or up to 80 degrees from the horizontal axis.

15. A flood defence device as claimed in claim 1 where the flood defence device is a door, a window, a patio door, a bi-fold door, a stable door, a French window or a garage door.

16. A flood defence device as claimed in claim 1, wherein the flood defence device is mountable in a frame using a compressing hinge.

17. A flood defence device as claimed in claim 16 wherein the hinge comprises a first portion, a second portion and elastic means, the elastic means being attachable to the first portion and the second portion such that, at rest the first portion and second portion are in contact with one another, the first portion and second portion being provided with complementary sealing means which provide a seal between the first portion and the second portion.

18. A flood defence device as claimed in claim 1, wherein the flood defence device is provided with sealing means, the sealing means extending at least as high as the level of the flood defence device.

19. A flood defence device as claimed in claim 1, wherein the flood defence device is provided with sealing means, the sealing means only extending as high as the level of the flood defence device.

20. A flood defence device as claimed in claim 18, wherein the sealing means is adapted to form a water-tight seal when the flood defence device is under compression.

21. A flood defence device as claimed in claim 18, wherein the sealing means comprises a projection and a waterproof member, the projection and waterproof member each being situated on the flood defence device and/or the frame and being in registration with each other; such that when the flood defence device is compressed the projection is forced into the waterproof member thereby giving a waterproof seal.

22. A flood defence device as claimed in claim 18, wherein the sealing means comprises a pair of magnets, one of the pair of magnets being situated on the flood defence device and the complementary magnet being situated on the frame and being in registration with each other; such that when the flood defence device is closed the magnets contact each other forming a seal between the flood defence device and the frame.

23. A flood defence device as claimed in claim 1, wherein the door or window frame is provided with re-inforcement.

24. A flood defence device as claimed in claim 23 wherein the flood defence device frame is hollow and the reinforcement comprises inserting a substance into at least part of the space within the flood defence device frame.

25. A flood defence device as claimed in claim 24 wherein the substance comprises expanding foam or resin.

26. A flood defence device as claimed in claim 23 whereby the re-infocement comprises a metal framework.

27. A flood defence device as claimed in claim 1, wherein the flood defence device is provided with a rack and pinion locking mechanism.

28. A flood defence device as claimed in claim 27 wherein the rack and pinion locking mechanism is operated by a handle, roller chain, cable or motorised mechanism.

29. A flood defence device as claimed in claim 27, wherein the rack and pinion locking mechanism includes a locking and sealing member comprising a compression roller, locking bolt and sealing bar.

30. A flood defence device as claimed in claim 1, including an indicator which indicates when the water reaches a predetermined level.

31. A flood defence device as claimed in claim 30 wherein the indicator includes a visual or an audible alarm.

32. A flood defence device as claimed in claim 33 wherein the visual alarm comprises a tube configured to fill with water when the water or a light.

33. A flood defence device as claimed in claim 1, wherein the device further comprises a locking mechanism which prevents the door being opened when the flood water is above a predetermined level.

34. A flood defence device as claimed in claim 33 wherein the locking mechanism comprises a lever which prevents turning of a handle in the flood defence device.

35. A flood defence device as claimed in claim 36 wherein the lever is driven by a waterwheel.

36. A wall including a flood defence device as claimed in claim 1.

37. A wall as claimed in claim 36 wherein the wall is a cavity wall and a cavity beam is inserted between the inner and outer leaves of the wall.

38. A hinge comprising a first portion, a second portion and elastic means, the elastic means being attachable to the first portion and the second portion such that, at rest the first portion and second portion are in contact with one another, the first portion and second portion being provided with complementary sealing means which provide a seal between the first portion and the second portion.

39. A hinge as claimed in claim 37 wherein the elastic means comprises a first arm attached to the first portion, a second arm attached to the second portion, the first and second arms being hingeably attached to one another.

40. A hinge, as claimed in claim 38 wherein the first and second arms are hingeably attached using a spring.

41. A hinge as claimed in claim 38, wherein the sealing means comprises a projection on one of the first portion and the second portion and a complementary receiving means on the other of the first portion and the second portion, the projection and receiving means being in contact when the hinge is at rest.

42-45. (canceled)
